(19) United States
(12) Patent Application Publication
(10) Pub. No.: US 2023/0087515 A1
(43) Pub. Date: Mar. 23, 2023

(54) LOCK ASSEMBLY FOR A VEHICLE LOAD COMPARTMENT

(71) Applicant: LOCKS4VANS LTD., Gravesend Kent (GB)

(72) Inventor: Christopher BATTERBEE, Gravesend Kent (GB)

(73) Assignee: LOCKS4VANS LTD., Gravesend Kent (GB)

(21) Appl. No.: 17/799,887

(22) PCT Filed: Feb. 12, 2021
(86) PCT No.: PCT/GB2021/050353

§ 371 Date: Aug. 15, 2022

(30) Foreign Application Priority Data
Feb. 13, 2020 (GB) 2002015.2

(51) Int. Cl. E05B 83/12; E05B 85/22

(52) U.S. Cl. CPC E05B 83/12; E05B 85/22

(57) ABSTRACT

A lock assembly is intended to improve the security of a roller shutter door or tailgate door, especially on a vehicle used to make frequent deliveries and collections. The lock assembly provides a bolt (15) mounted in an enveloping housing (1) to be displaced solely by the action of a key placed in a lock (14) and rotated. Rotation displaces the bolt (15) between an extended condition where the bolt can engage in a staple (10) so locking the door closed, and a retracted condition where the door can be opened.

### TECHNICAL FIELD

A lock assembly mainly for use in securing a load compartment door on a vehicle, particularly a vehicle where the load compartment door is frequently opened and closed as the vehicle operator stops to make deliveries or collections. The compartment door will usually be a vertically displaced panel or panels, (eg of the roller shutter type) or a tailgate.

Roller shutter doors usually have a roller located adjacent the roof of the load compartment in a door frame. The shutter is provided by an articulated assembly of horizontal laths arranged to roll around the roller as the door is lifted to open and to unroll as the door is pulled down to close.

A tailgate door is a rigid panel supported in a door frame by horizontal hinges mounted to a top frame member of the door frame. The weight of the tailgate may be counterbalanced, for example by one or more bistable pneumatic rams.

### PRIOR ART

Existing locking mechanisms may be unreliable in operation, for example wind or other environmental factors may prevent a tailgate slamming shut properly, without the fact being evident to the operator without checking, ie tugging the door. Similar problems can occur with locks on roller shutter doors. Where operators make frequent stops there is time pressure and environmental factors which may discourage the operator from properly securing the door leaving the compartment vulnerable to theft. Roller shutter doors commonly use some form of padlock. A padlock requires the locking process of: aligning two staples one on the door and one on the door frame; threading the padlock shackle through the staples, closing the shackle and actuating the lock, usually by turning a key. The reverse process is required to open the door. This is obviously time consuming and susceptible to error.

Tailgate doors usually use a cam actuated, bistable, sprung lock where one or more cams rotate into engagement or disengagement conditions with a staple secured to the lower door frame. Locking the door requires the door to be pressed fully closed. Unlocking the door requires a key to be turned in the lock. While a much less laborious process than use of a padlock it is quite easy to close the door only on the weight of the door and force from pneumatic rams by mistake.

A bistable cam lock may be used with roller shutter doors, but the mechanism of shutter doors makes precise alignment of the staple and cams problematic.

It Is an object of the present invention to provide a highly secure lock assembly for a load compartment door of a vehicle which alleviates at least some of the aforementioned technical problems.

### SUMMARY OF INVENTION

A lock assembly for a vehicle load compartment comprising:

a housing capable of engagement with a load compartment door of a vehicle;

a bolt rack mounted for linear displacement in the housing;

an actuator mounted for rotation in the housing and engageable with the bolt rack to induce said linear displacement;

a key operable rotatable locking device mounted into a lock stator and coupled to the actuator, said lock stator being irrotatably mounted to the housing, whereby rotation of the locking device can induce linear motion of the bolt.

In a preferred embodiment of the lock assembly the housing is adapted to be mounted on the outside of the compartment door and incorporates a recess into which a staple mounted on the outside of the door frame is receivable. When received into the recess the staple is preferably wholly enclosed by the housing. Preferably the bolt rack linearly displaces an elongate bolt such that the bolt can engage in the staple when the bolt is displaced to a locking condition is withdraw from the staple when the bolt is retracted to an unlocked condition. Preferably the housing incorporates an aperture into which a projected tip of the bolt is received in the locking condition. Preferably the housing fully encloses the aperture so that neither the staple or any part of the bolt can be accessed from outside the housing in the locked condition.

Preferably the actuator is a toothed pinion engaged with rack teeth formed on the bolt rack. This arrangement allows for sufficient mechanical advantage for the bolt to be directly displaced between the locked and unlocked condition without requiring any additional operation such as turning a lever or knob.

In alternate embodiments the actuator may be provided by a cam engageable with a cam track formed on the bolt rack.

The locking device and stator maybe provided by a euro cylinder lock assembly modified to accommodate the preferred actuator.

Where the actuator is a pinion the lock assembly may include more than one bolt rack, each bolt rack being guided by features within the housing to move substantially oppositely to or perpendicularly to the other rack. In a multi bolt rack lock assembly of this type the bolt racks may project from a housing mounted on the inside of the compartment door. The ends of each bolt rack project from the housing. Each bolt rack end may be provided with means to link it with a connector. Connectors may be a stiff connecting rod or flexible cable and the connecting means may be a hole to securely receive an end of the connector bent into a crank shape. Each connector is able to link the lock assembly to a bolt assembly operable between the door and the door frame to secure the door in a closed condition at multiple points around the door frame. The simultaneous movement of each bolt rack between a locking and an unlocking condition causes simultaneous disengagement of each bolt assembly.

In order to minimise the size and weight of the lock each bolt rack is preferably formed in a crank shape, ie from substantially three limbs, two end limbs being parallel and the intermediate limb extending substantially at right angles to join the nearest ends of the end limbs. An internal end limb will be formed with rack teeth to engage the pinion. In order to further reduce the size and weight of the lock assembly at least one of the bolt racks, intended to move mutually oppositely may have an internal limb with a through slot extending longitudinally. A second and third bolt rack may be formed with an internal limb adapted to slide through the slots in the limbs of the other bolt racks while each couples with the pinion. In an alternative arrangement, two of the bolt racks may be formed with a through slot such that the third bolt rack can slide through each of the slots. These arrangement allows the depth of the lock to be minimised.

The multi-bolt rack lock assembly can be readily modified to provide any of single, double or triple bolt rack assemblies from a common set of components.

Preferably the multi bolt rack lock assembly has a spring to urge each bolt rack to an extended condition. An advantage of the assembly is that only a single compression spring is required to urge each bolt rack.

### BRIEF DESCRIPTION OF DRAWINGS

Embodiments of a lock assembly for a vehicle load compartment constructed in accordance with the present invention will now be described, by way of example only, with reference to the accompanying figures, in which:

FIG. 1.1 is an east perspective view of a first embodiment from in front and showing the east side;

FIG. 1.2 is a west perspective view of the first embodiment from the west and the back;

FIG. 1.3 is a perspective view of the first embodiment from the east and in front showing internal details;

FIG. 2.1 is a SE isometric view of a first variant of a second embodiment;

FIG. 2.2 is a SE isometric view of the second embodiment with a cap removed to show interior features;

FIG. 2.3 is a plan view of the second embodiment of FIG. 2.2;

FIG. 2.4 is a SE isometric view of the second embodiment with the housing removed;

FIG. 3.1 is a SE isometric view of a second variant of the second embodiment; and

FIG. 3.2 is a SE isometric view of the second variant with a cap and lock device removed to show features internal to the housing.

### DETAILED DESCRIPTION

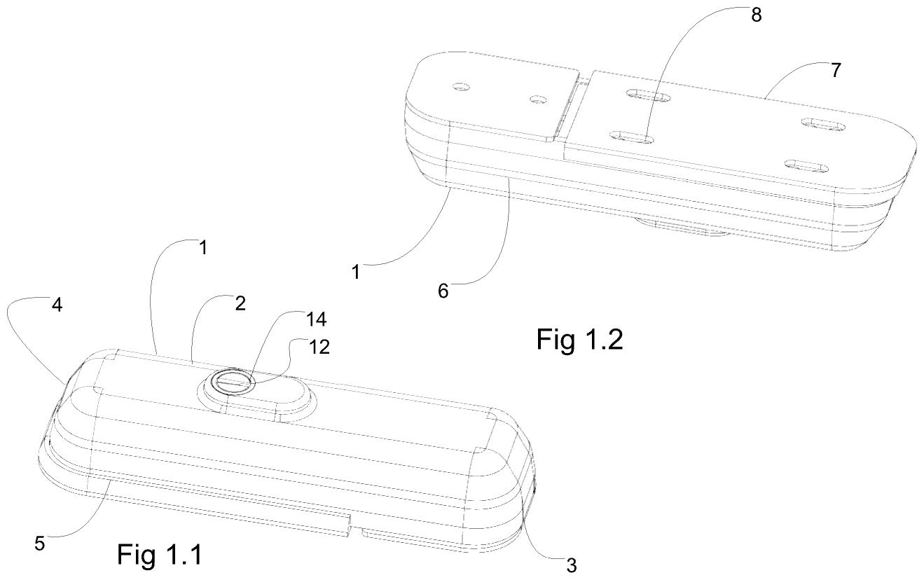

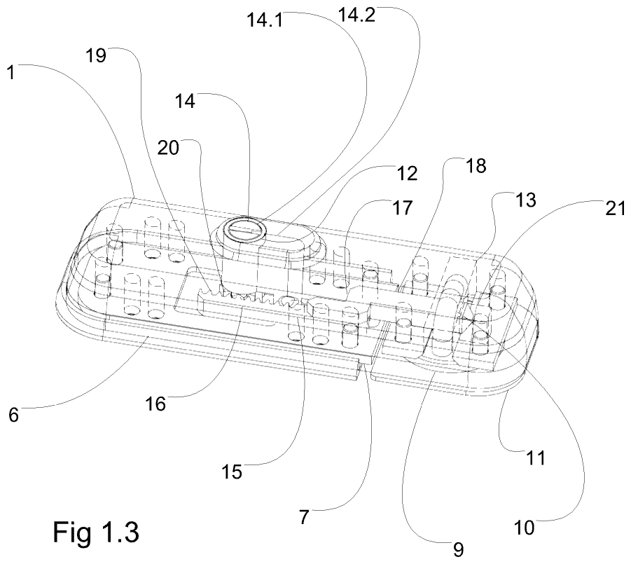

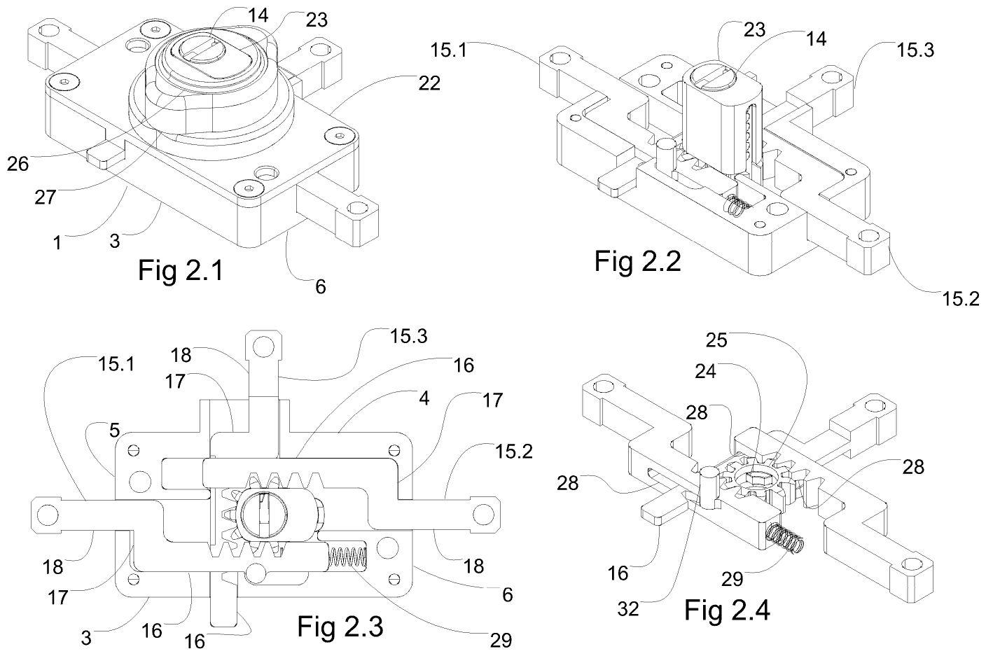

FIGS. 1.1-1.3 show a lock assembly having a hollow housing 1 having a front panel 2 top panel 3 bottom panel 4 and left and right side panels 5 and 6 respectively. A back panel 7 is secured into the open back of the housing by means of machine screws. The back panel 7 provides threaded screw holes 8 whereby the lock assembly can be mounted on the outside of a vehicle compartment door using machine screws. FIG. 1.2 also shows the back of a rubber protective mounting gasket 9 whereby a staple 10 can be mounted to a door frame of the load compartment. A rubber mounting gasket 11 is provided to sit between the back panel 7 and the door.

The housing provides an aperture 12 in the front panel 2 through which the end of a cylinder of a euro lock 14 can be accessed. The Euro lock comprises a cylinder 14.1 sleeved into a stator 14.2. The housing 1 incorporates a recess 13 into which the staple 10 mounted on the outside of the door frame is receivable. When received into the recess the staple is wholly enclosed by the housing 1.

A bolt rack 15 is mounted into guide formations machined into the inside of the integral housing 1 which constrain the bolt to move linearly in the top to bottom direction. The bolt rack 15 is formed of a rack limb 16, an intermediate limb 17 perpendicular to the rack limb and a elongate bolt limb 18 parallel to the rack limb forming a crank shaped bolt rack 15. The rack limb is formed with an array of rack teeth 19 in one side face arranged to engage with the teeth of a pinion 20. The pinion 20 is directly coupled to an internal end of euro lock barrel 14 whereby the rotation of the lock barrel 14.1 using a compatible key causes rotation of the pinion 20. The rotation of the pinion causes linear displacement of bolt rack 15 to extend the bolt rack and bolt limb 18 to engage in the staple 10 or to retract the bolt limb freeing the door to open.

The housing incorporates an aperture 21 formed in the side wall of the recess 13 opposite the bolt limb 18. The tip of the bolt limb 18 is received into the aperture 21 as shown in the locking condition. The housing 1 fully encloses the recess 13 and aperture 21 so that neither the staple 13 or any part of the bolt rack 15 can be accessed from outside the housing in the locked condition.

The second embodiment of the lock assembly is intended to mount the housing 1 to the inside of a vehicle compartment door. The housing 1 is formed of an integral body with a rear face (not shown) a top surface 3 bottom surface 4 right side wall 5 and left side wall 6. The body has an open top normally closed by a cap plate 22. Cap plate 22 is perforated by an aperture (not shown) to accommodate euro lock cylinder and barrel assembly 14, 23. The internal end of the euro lock barrel couples with features 24 formed in axial hole 25 in the pinion 20 mounted for rotation in the housing. A plug 26 and turn button 27 encircle the lock cylinder 23 where they are exposed when mounted on the outside of a door.

The pinion 20 is coupled to each of three bolt racks 15.1, 15.2 and 15.3. Each of the bolt racks is crank shaped and received into guide features formed inside the housing body 1 which constrain the bolt rack to move reciprocally in a linear direction. In the case of bolt rack 15.1 it is constrained to move out to the right and in to the left, in the case of bolt rack 15.2 it is constrained to move out to the left and in to the right, in the case of bolt rack 15.3 it is constrained to move out towards the bottom and in towards the top. Each bolt rack is formed of three rack limbs 16, 17, 18 as with the previous embodiment.

The bolt racks of the present embodiment differ from the first embodiment in that each of rack limbs 16 of bolt racks 15.1 and 15.2 are formed with elongate guide slots 28. The rack limb 16 of bolt rack 15.3 is formed of much reduced thickness by comparison with the rack limbs of the other bolt racks to be a sliding fit into the slots 28 whereby each rack limb is directly coupled to the pinion 20 and moves in a common plane.

Each bolt limb 18 is provided with a hole formed front to back to provide means for connection to a stiff or flexible connector whereby the lock assembly can actuate a remote bolt assembly operable between the door panel and the door frame.

A compression spring 29 is provided to act between the internal end of one of the bolt racks 15.1 and a shoulder formation inside the body. This urges all of the bolt racks to an extended condition.

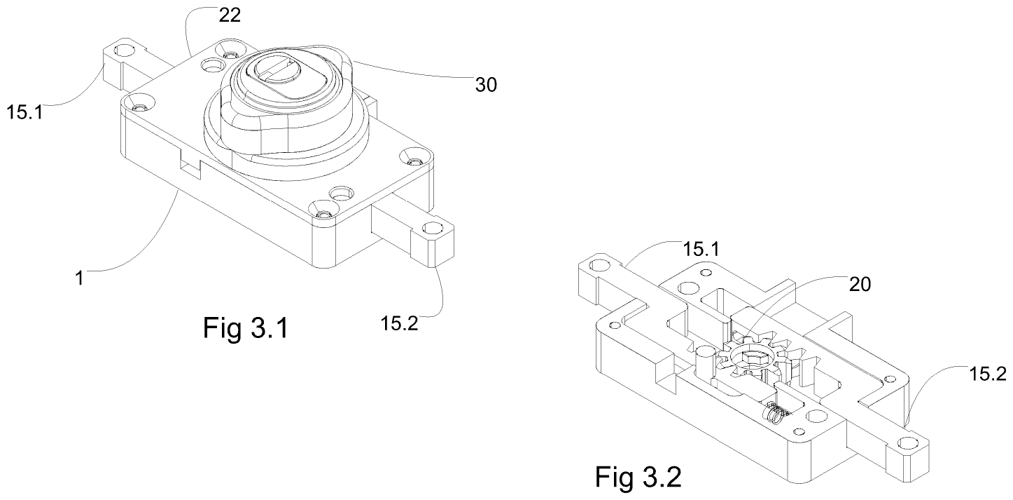

The second variant of the second embodiment shown in FIGS. 3.1 and 3.2 illustrates how a lock assembly generally similar in operation but having only two oppositely moving bolt racks can be provided using substantially the same components but omitting the bolt rack 15.3.

Where additional torque may be desired to turn the pinion a turn ring 30 may be provided around the lock cylinder mounted onto a cylindrical plug 31. The turn ring couples with the bolt rack 15.1 by means of a pin 32 which projects forwards through a slot (not shown) formed in the cap to engage in a pin hole (not shown) formed in the underside of the turn ring. When the lock barrel is unlocked the turn ring can be grasped to urge the bolt rack 15.1 against the spring force of the spring 29. Coupling through the pinion 20 will displace the other bolt racks 15.2 and 15.3.

1-17. (canceled)

18. A lock assembly for a vehicle load compartment comprising:
a housing capable of engagement with a load compartment door of a vehicle;
at least a first bolt rack and a second bolt rack mounted in and guided by features in the housing to be linearly displaced in one of mutually; opposite directions, or perpendicular directions;
an actuator provided by a toothed pinion mounted for rotation in the housing and engageable with rack teeth formed on each of the first and second bolt racks to induce said linear displacement;
a key operable rotatable locking device mounted into a lock stator and coupled to the actuator, said lock stator being irrotatably mounted to the housing, whereby rotation of the locking device can induce linear motion of the first bolt rack;
the actuator providing sufficient mechanical advantage for the bolt to be directly displaced between the locked and unlocked condition solely by turning the key in the locking device;
wherein at least one bolt rack includes a slot through which at least one other bolt rack (15.3) slides.

19. A lock assembly according to claim 18 wherein the housing is adapted to be mounted on the outside of the compartment door and incorporates a recess into which a staple mounted on the outside of the door frame is receivable.

20. A lock assembly according to claim 19 wherein, when received into the recess the staple is preferably wholly enclosed by the housing.
